(19) United States
(12) Patent Application Publication
(10) Pub. No.: US 2014/0100876 A1
(43) Pub. Date: Apr. 10, 2014

(54) SYSTEM AND METHOD FOR PATIENT PLACEMENT IN CARE FACILITY

(71) Applicant: At Cura Solutions, Inc., Huntington Beach, CA (US)

(72) Inventors: Barbara SAVAGE, Huntington Beach, CA (US); James ZARIAN, Corona Del Mar, CA (US)

(73) Assignee: At Cura Solutions, Inc., Huntington Beach, CA (US)

(21) Appl. No.: 14/046,100

(22) Filed: Oct. 4, 2013

Related U.S. Application Data
(60) Provisional application No. 61/744,914, filed on Oct. 5, 2012.

(51) Int. Cl. G06F 19/00

(52) U.S. Cl. CPC G06F 19/322
USPC 705/3

(57) ABSTRACT

Techniques for automated. selection of a patient care facility.

### CROSS-REFERENCE TO RELATED APPLICATIONS

This application is a non-provisional application of U.S. Provisional Application No. 61/744,914, filed Oct. 5, 2012, the entire contents of which are incorporated herein by reference in their entirety.

### TECHNICAL FIELD

This disclosure relates generally to the field of health care, and more particularly, to techniques for automated selection of a health care facility for on-going patient care.

### BACKGROUND

The placement of a patient from a clinical facility, such as a hospital, into an appropriate non-clinical facility, such as a residential care facility, is a critical decision that impacts the ability of the patient to receive appropriate post-clinical care. As the amount of time that a patient remains is the hospital or a skilled nursing facility continues to be shortened, effective post-clinical placement is even more critical to the success of the patient treatment plan.

For example, once the patient is ready to be released from a clinical treatment facility, the attending physician may direct the patient to return home under the supervision of a family member, a caregiver, a registered nurse, etc. Alternatively, attempts may be made to identify and place the patient in a care facility, such as an assisted-living facility, a skilled-nursing facility, a hospice facility, an independent living facility, etc. The decision to place the patient into the appropriate facility must typically be made expeditiously and depends on many factors. Such placement depends on complex interactions between a large number of variables, including the patient's personality, gender, physical and cognitive health, socioeconomic status, religion, ethnic background, energy level, level of activity required, education, interests, appearance and many other potential factors. Similarly, each facility has its own set of variables, including the level of care (i.e., assisted living, skilled nursing, hospice, etc.), the proximity of the facility to the primary physician, the proximity of the facility to the patient's home and/or family members, languages spoken at the facility, and many other factors.

The large number of variables involved in determining a patient placement makes it difficult to select a facility, much less select a facility that provides the best environment for success in post-clinical care and treatment of the patient. Accordingly, placement services are often unable to reliably predict the success of the placement, and therefore patients and their families are often disappointed with the results of the placement.

Thus, there is a need for a process for effectively matching patients with facilities that best meet their needs.

### BRIEF DESCRIPTION OF THE DRAWINGS

FIG. 1 is a block diagram of a patient placement system.

FIG. 2A is a block diagram illustrating a web application that provides patient placement services.

FIG. 2B is a flow chart illustrating one example of a process for registering different classes of users.

FIG. 2C is a simplified flow chart illustrating one example of a process for selecting a facility for patient placement.

FIG. 3 is a flow chart illustrating one example of a process for registering a patient care facility with a cloud-based patient placement service.

FIG. 4 is a flow chart illustrating one example of a process for registering a care professional with a cloud-based patient placement service.

FIG. 5 is a flow chart illustrating one example of a process for obtaining an assessment of patient needs from a registered care professional in a cloud-based patient placement service.

FIG. 6 is a flow chart illustrating one example of a process for providing patient-related access to third parties in a cloud-based patient placement service.

FIG. 7 is a flow chart illustrating one example of a process for submitting a patient having a need for placement to a cloud-based patient placement service.

FIG. 8A lists a number of individual factors related to a patient's condition and weights assigned to those factors.

FIG. 8B lists a number of individual factors related to a patient's level of care and weights assigned to those factors.

FIG. 8C lists a number of individual factors related to a variety of different patient issues.

### DETAILED DESCRIPTION

This disclosure describes computer-implemented systems and methods for effectively placing a patient in a post-clinical patient care facility, and for tracking the patient as he or she moves from one level of care to another level of care. However, the systems and methods described herein may be applied to any type of custodial care placement and tracking from one level of care to another level of care, including any type of care facility for the elderly, disabled, orphaned, troubled, sick, etc.

In the following detailed description, reference is made to the accompanying drawings, which form a part of the description and in which are shown, by way of illustration, specific example implementations. Although these implementations are described in detail, it should be understood that these examples are not intended to be limiting, and that other implementations may also be used and changes may be made to the implementations described herein without departing from the spirit and scope of the disclosure. For example, the methods illustrated and described herein are not necessarily performed in the order indicated. Further, the methods may include more or fewer blocks or steps than are indicated. In some implementations, blocks described herein as separate blocks may be combined. Conversely, what may be described herein as a single block may be implemented in multiple blocks.

The implementations described herein may be embodied in various types of hardware, software, firmware, and combinations thereof. For example, some techniques disclosed herein may be implemented, at least in part, by computer-readable media that include program instructions, state information, etc., for performing the various services and operations described. Examples of program instructions include machine code, such as produced by a compiler, and files containing higher-level code that may be executed by a computing device such as a server or other data processing apparatus using an interpreter. Examples of computer-readable media include, but are not limited to, magnetic media such as hard disks, floppy disks, and magnetic tape; optical media such as CD-ROM disks; magneto-optical media; and hardware devices that are specially configured to store program instructions, such as read-only memory (“ROM”) devices and random access memory (“RAM”) devices. These and other features of the disclosed implementations will be described in more detail below with reference to the associated drawings.

### 1. Care Team

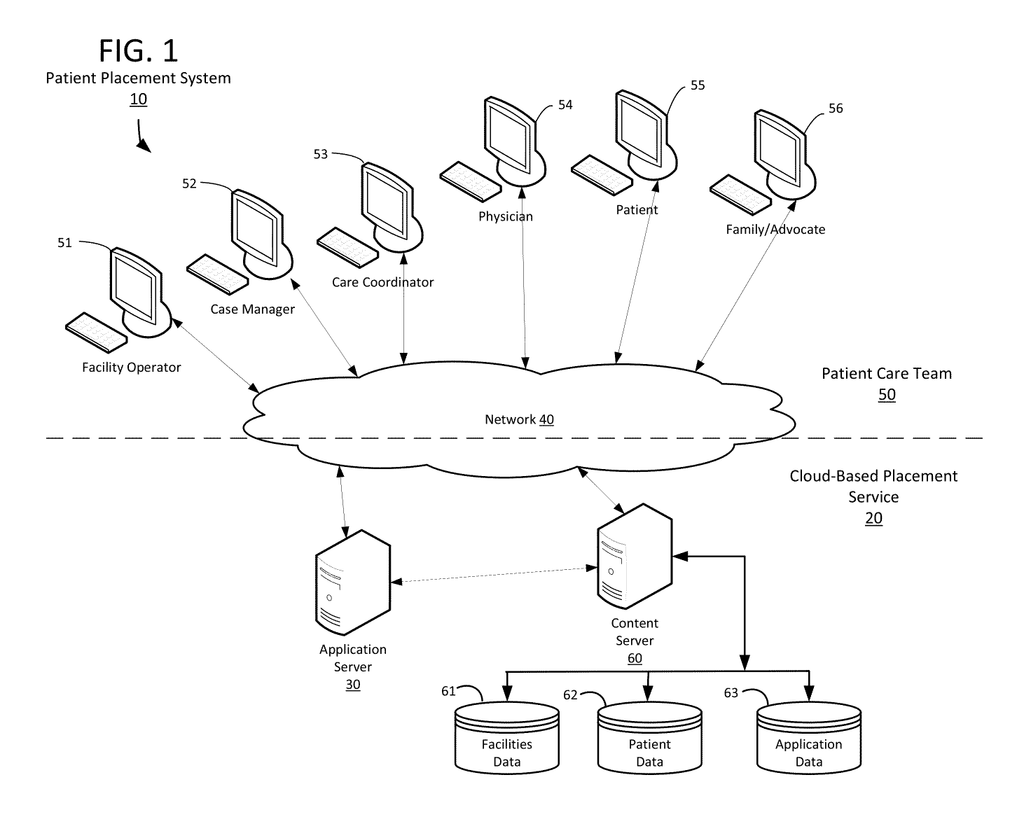

FIG. 1 illustrates a system 10 that provides a cloud-base patient placement service 20 that is hosted by an application server 30 via a network 40 accessible to multiple client computers that form a patient care team 50. The application server has access to a database that stores at least facilities data 61, patient data 62, and application data 63, through content server 60 either directly (dotted line) or through the network 40. In one embodiment, the placement service 20 is implemented as a web application that runs on the application server 30 and is configured to interact with various different members of the patient care team 50. Different members of the patient care team 50 may have different levels of access to patient-related records. Further, privacy considerations as dictated by applicable rules and regulations, e.g., Health Insurance Portability and Accountability Act (“HIPAA”), must be implemented in all patient-related routines and methods of the web application.

The patient care team 50 includes at least a facility operator 51 and a case manager 52. The facility operator 51 provides detailed information about the various patient care features of the facility, such as number of beds, number of staff, availability of in-house physical therapy, etc., upon registering the facility with the placement service. Thereafter, the facility operator generally only interacts with the service to provide information updates. The case manager 52 interacts with the patient to coordinate all of the patient's needs for post-clinical placement and treatment, including insurance, transportation, medical equipment and supplies, etc.

The patient care team 50 preferably includes many other participants, including case coordinator 53, physician 54, patient 55, and other family members or patient advocates 56. Other participants could also be part of the patient care team, either as regular or temporary members, such as suppliers of durable medical equipment and medical supplies, and insurance representatives.

As discussed more fully below, the patient placement service 20 is provided so that the patient care team may be readily interconnected in real time or near real time to facilitate better communication and coordination related to the care of the patient.

### 2. Platform for Patient Placement

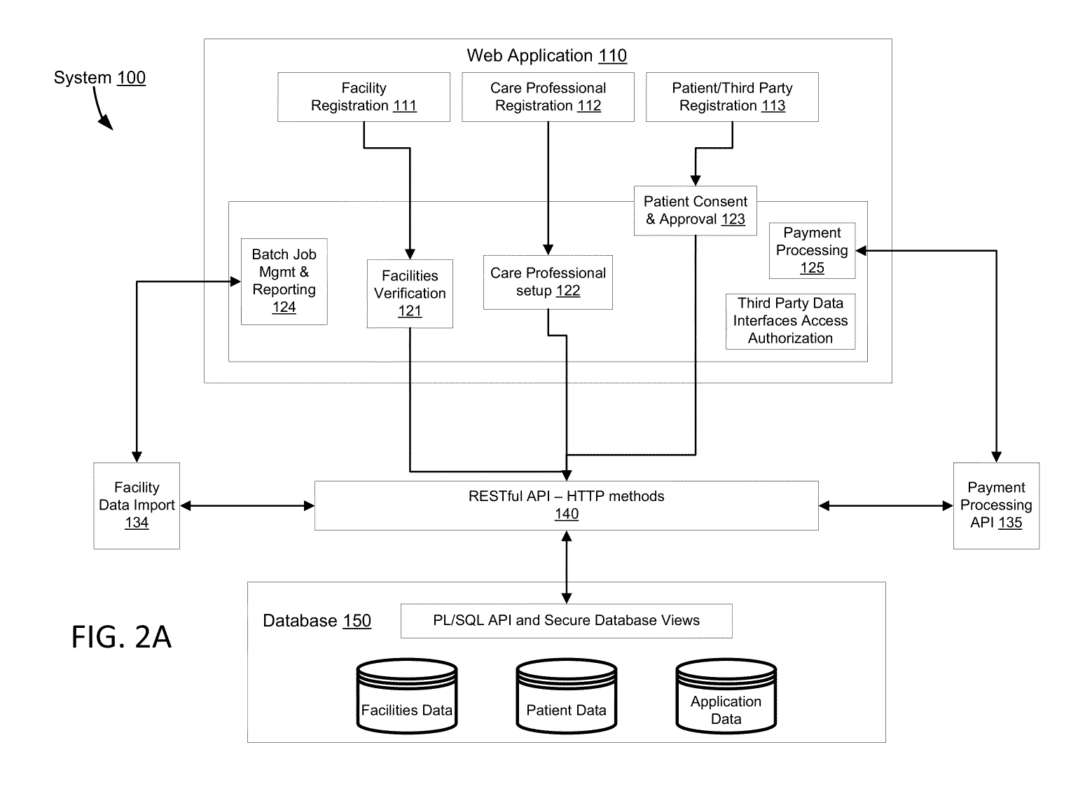

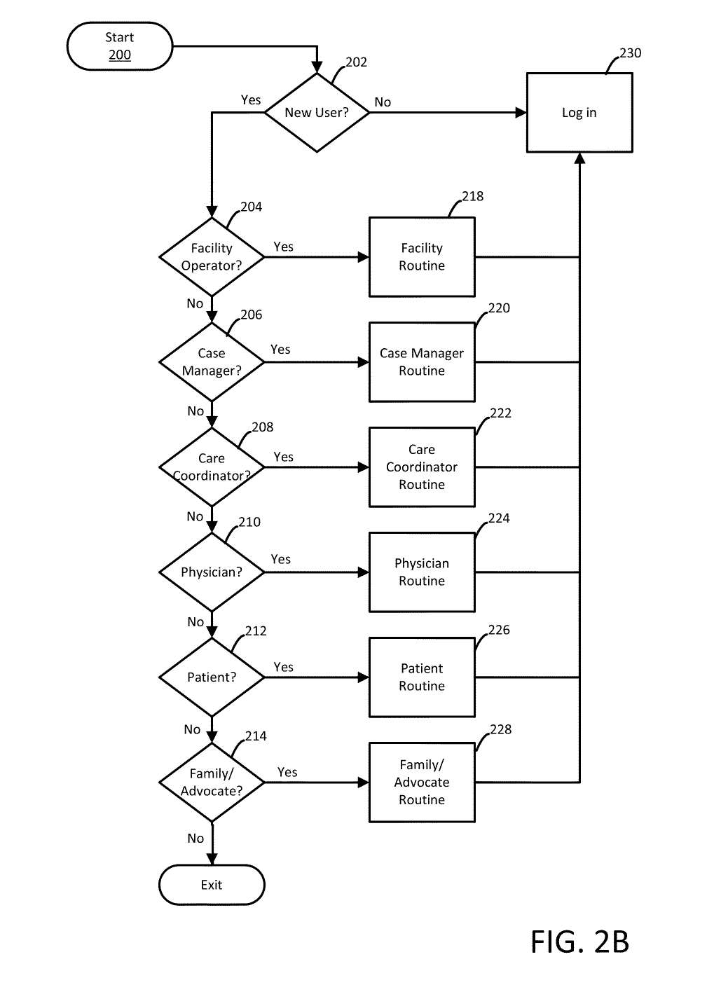

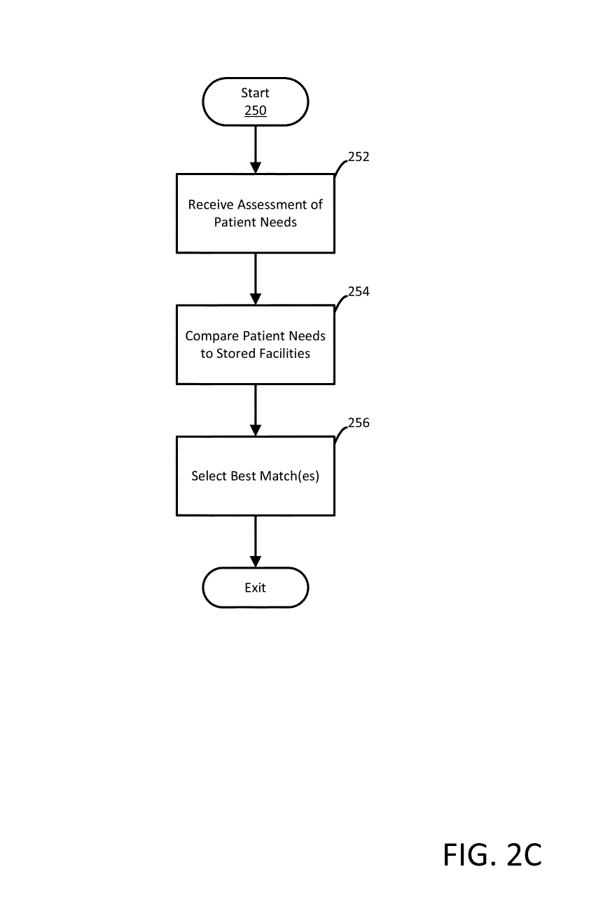

FIG. 2A illustrates one example of a platform 100 for providing a cloud-based placement service that matches a patient with a care facility, and tracks the placement of the patient. The platform 100 is preferably available as a service to authorized users, for example, implemented as a web application 110 that resides on a network-based server, such as server 12 shown in FIG. 1. The web application 110 includes various programmed routines, such as routines 111, 112, 113, that provide the necessary user interfaces for interaction with different types of users for registration with the service and for on-going connections with the service as appropriate. In this example, routine 111 controls interaction with facilities, routine 112 controls interaction with care professionals, and routine 113 controls interaction with third parties including family and outside providers, such as pharmacy, medical equipment and supplies, etc. Other routines and other configuration are possible, and the examples described herein are merely illustrative.

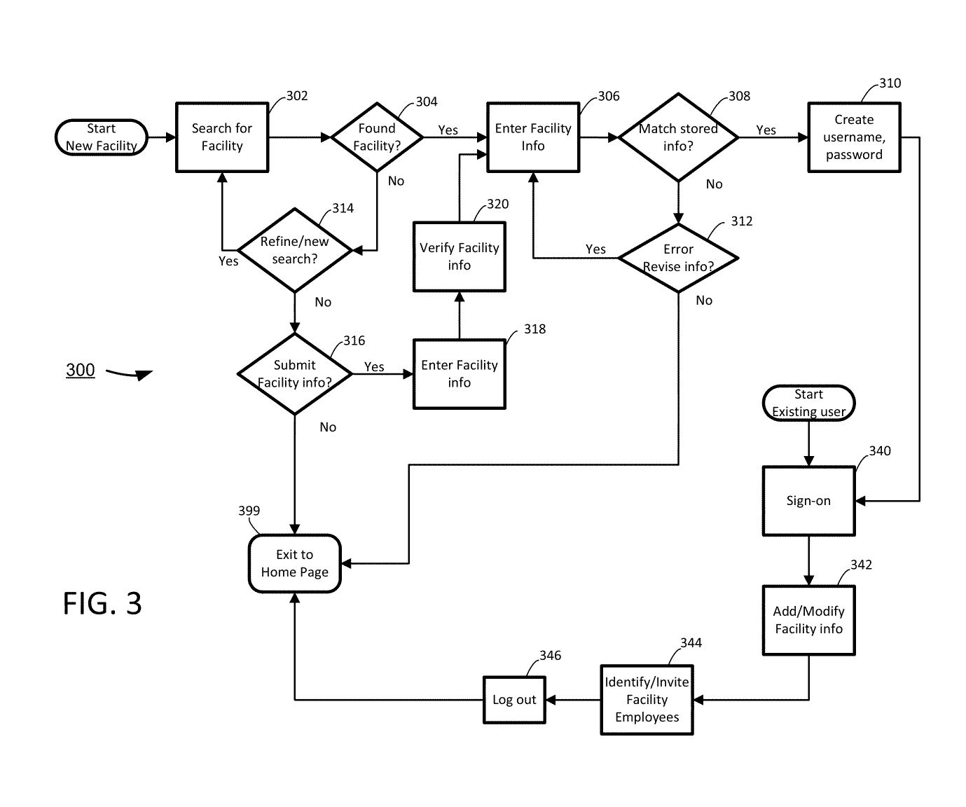

The first fundamental core of information that is required to support the placement service is detailed information about the facilities that are available for patient care, including number of beds, staff, etc. This facilities information is developed through a facility operator, such as its owner, by registering the facility with the service using routine 111 of web application 110, which is discussed in more detail with reference to FIG. 3 below.

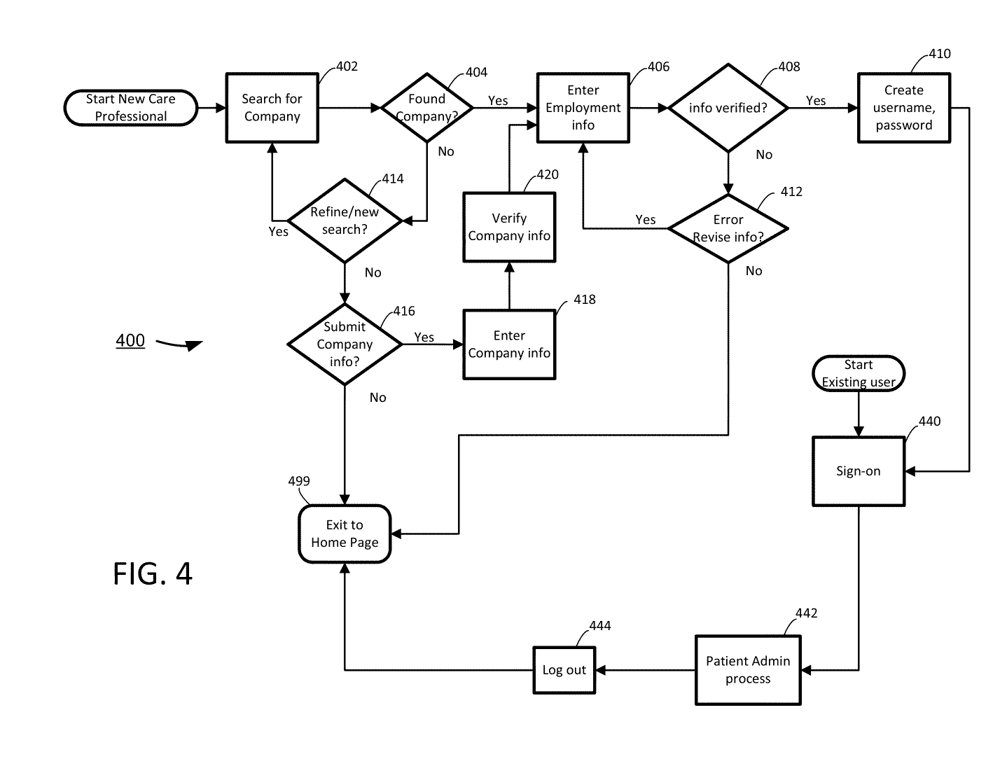

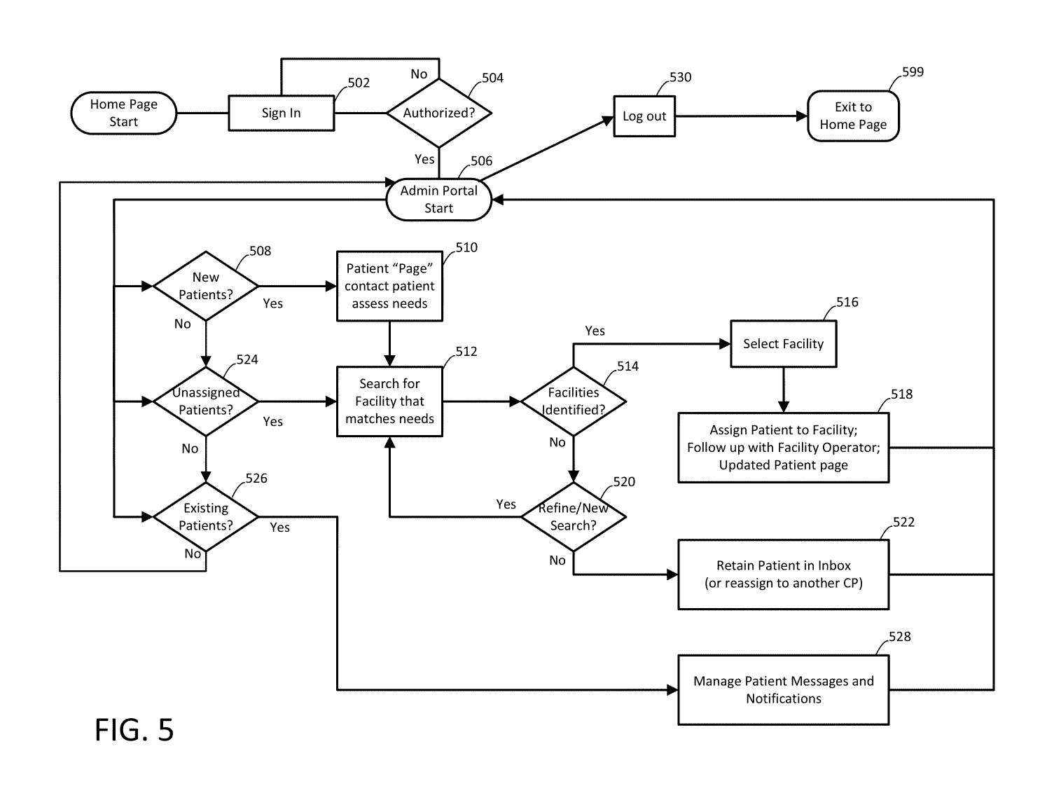

The second fundamental core of required information is detailed information from a care professional about the patient needs and assessment. This patient information is typically developed and maintained through a case manager at the hospital which has treated the patient by registering with the service and providing an assessment of the patient's needs using routine 112, which is discussed in more detail with reference to FIGS. 4 and 5 below. The primary objective of the hospital is to provide an effective clinical treatment and an effective post-clinical treatment plan for any patient, then discharge the patient. If the treatment plan is carried out and effective for the patient, then the likelihood of patient's readmission to the hospital is minimized. However, the success of an on-going treatment plan is of course dependent upon effective placement of a patient.

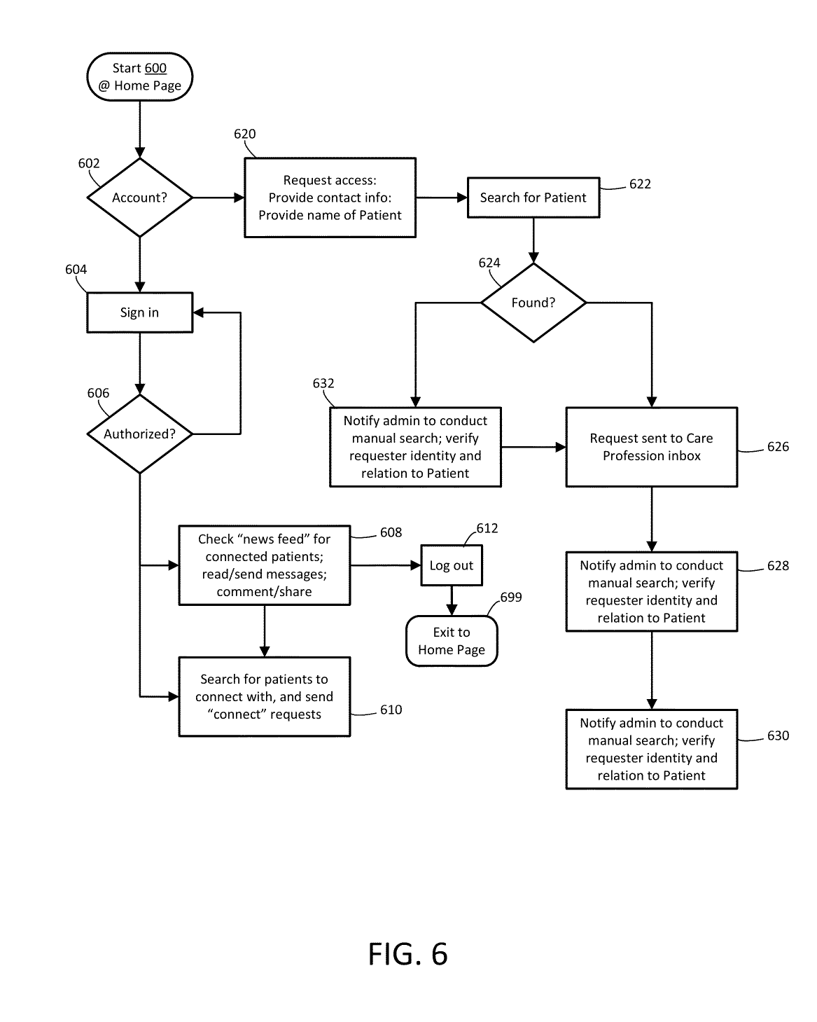

Although the patient placement service could be operated using only the information from facilities through routine 111 and from care professionals through routine 112, families and other third party providers and suppliers are also valuable sources of information that can be obtained through routine 113, as discussed in more detail with reference to FIG. 6 below.

The web application 110 also includes a service portal 120 that provides a centralized interface for the provider of the service, e.g., through an administrator and/or programmed or automated routines, to interact as necessary or appropriate to maintain the service and the web application. For example, the service portal 120 includes verification routines 121, 122 and 123, which correspond to user input routines 111, 112, and 113, respectively. Verification routine 121 manages a process for verifying a new facility entered by a user, for example, in step 318 of FIG. 3, described below. Verification routine 122 manages a process for registering and authorizing care professionals, for example, in step 420 of FIG. 4, described below. Verification routine 121 manages a process for obtaining patient consent to access by a third party, for example, in step 628 of FIG. 6, described below.

The service portal 120 also includes other administrative routines, such as routine 124 for batch job management including reporting screens, and routine 125 for payment processing. The batch job management routine 124 is handled by a batch process 134 in the server, and the payment processing routine 125 is handled by batch process 135 in the server. All of the routines of the service portal 120 interface with the database 150 through API and HTTP methods 140.

FIG. 2B illustrates one example of a process 200 that directs different classes of uses to different registration and/or administrative routines. Decision step 202 considers whether the user is a new user. If so, then decision step 204 asks whether the user is a facility operator. If not, then decision step 206 asks whether the user is a case manager. If not, then decision step 208 asks whether the user is a care coordinator. If not, then decision step 210 asks whether the user is a physician. If not, then decision step 212 asks whether the user is a case patient. If not, then decision step 214 asks whether the user is a family member or advocate.

If the user is a facility operator in step 204, then the user is redirected to routine 218 for facility operators. If the user is a case manager in step 206, then the user is redirected to routine 220 for facility operators. If the user is a care coordinator in step 208, then the user is redirected to routine 222 for care coordinators. If the user is a physician in step 210, then the user is redirected to routine 224 for physicians. If the user is a patient in step 212, then the user is redirected to routine 226 for patients. If the user is a family member or advocate in step 214, then the user is redirected to routine 228 for family member or advocates. Other classes of users could also be configured.

FIG. 2C illustrates one example of a process 250 for selecting a care facility for a patient. In step 252, an assessment of the patient's needs with regard to features of a patient care facility is received, for example, from a care professional. In step 254, the patient's assessment is evaluated against the features of known facilities that are stored in a database. In step 256, one or more best fit matches between the needs of the patient and features of the facilities are selected.

In one embodiment, a best fit match between the needs of the patient and the features of the facilities can be determined by a statistical analysis of individual factors that define the patient needs and/or the facility features. For example, each of the factors can be assigned a weight, then combined mathematically to yield a score, and the highest scores will reflect the best matches between the needs of the patient and the features of the facilities.

### 3. Facility Registration and Administration

Referring to FIG. 3, a process 300 is illustrated for registering a patient care facility with the patient placement service, and for use of the placement service by the patient care facility. The facility registration process 300 is implemented by routine 111 of web application 110, which provides suitable instructions to render and process a series of graphical user interfaces to a user seeking to register and/or administer a facility. In step 302, the user, e.g. facility operator, is presented with dialog to enter a facility name. For example, dialog may be presented as one or more separate web pages or pop-up screens, or in any other known or preferred manner. If, in step 304, the facility entered by the user matches an entry found stored in the database, then in step 306, new dialog is presented to the user asking for key information about the facility, e.g., owner name, address, license number. If, in step 308, the key information entered by the user matches the information stored in the database for the facility, then new dialog is presented to the user in step 310 that creates a username and password for the user for the account that represents the facility.

If the key information does not match in step 308, then an error dialog is displayed in step 312 and the user is asked whether they want to revise their entry. If so, the user is returned to step 306 to revise their entry of key information. If not, the user is exited from the routine and returned to the system home page in step 399.

If, in step 304, the facility entered by the user does not find a match in the database, then in step 314, the user will be asked whether to continue with a refined or new search. If so, the user is returned to step 302 to refine the search or start over. If not, the user is asked whether to enter new facility information in step 316. If so, the user is presented with appropriate dialog in step 318 to enter information about the facility. If not, the user is exited from the routine and returned to the system home page in step 399.

The dialog presented in step 318 is designed to obtain information about the facility, including name, address, license number, number of beds, number of employees, physicians, nurses, etc., and is submitted to the administrator of the placement service in step 320 for verification and authentication. Any such verification and/or authentication steps may be carried out in whole or in part with suitable programmed instructions, including notification to an administrator of the placement service that human interaction may be required to complete the verification and/or authentication. Once the credentials of the facility have been verified, its information is added to the database.

Once a facility has been verified and added to the database, and at least one facility operator, e.g., administrator associated with the facility has registered with the service, then the administrator can sign on to the service in step 340, and add or modify details for the facility in step 342. In step 344, the administrator can initiate accounts for manager and employees of the facility. For example, once an account is created, the system can send an email to each individual employee with a link for completing the individual registration. In step 346, the user logs out of the facility page, and is returned to the home page of the service in step 399.

### 4. Care Professional Registration and Patient Administration

Referring to FIG. 4, a process 400 is illustrated for registering a care professional with the patient placement service. The care professional registration process 300 is implemented by routine 112 of web application 110, which provides suitable instructions to render and process a series of graphical user interfaces to a user seeking to register as a care professional. In step 402, the user is presented with dialog to enter a company name. If the company name entered by the user matches an entry found in the database in step 404, then in step 406, new dialog is presented to the user asking for verification of employment information for the user, e.g., name, position, employee identification number, etc. If, in step 408, the employment information entered by the user matches the information stored in the database for the that company, then new dialog is presented to the user in step 410 that creates a username and password for the user for the account that represents the care professional company.

If the employment information does not match in step 408, then in step 412, an error dialog is displayed and the user is asked whether they want to revise their entry. If so, the user is returned to step 406 to revise their entry of employment information. If not, the user is exited from the routine and returned to the system home page in step 499.

If, in step 404, the company name entered by the user does not find a match in the database, then in step 414, the user will be asked whether to continue with a refined or new search. If so, the user is returned to step 402 to refine the search or start over. If not, the user is asked whether they want to submit new company information in step 416. If so, the user is presented with appropriate dialog in step 418 to enter information about the facility. If not, the user is exited from the routine and returned to the system home page in step 499.

The dialog presented in step 418 obtains information about the company, including name, address, etc., and is submitted to the administrator of the placement service in step 420 for verification and authentication. The verification and/or authentication steps may be carried out in whole or in part with suitable programmed instructions, including notification to an administrator of the placement service that human interaction may be required to complete the verification and/or authentication. Once the credentials of the company have been verified, its information is added to the database.

Once a company has been verified and added to the database, and at least one care professional or administrator associated with the facility has been authorized and registered with the service, then the authorized user can sign on to the service in step 440 and engage in various administrative processes related to patient care in step 442. Finally, the user logs out of the care professional page in step 444, and is returned to the home page of the service in step 499.

FIG. 5 illustrates a process 500 for performing the various administrative processes referred to in step 442 of FIG. 4. The user navigates to the home page for the placement service, and logs into the service in step 502. If the user is authenticated in step 504, then the user is redirected to the portal home page in step 506. If not authenticated in step 504, the user is returned to the sign-on page in step 502.

On the portal home page in step 506, the user may receive notifications for new patients that need to be placed in a care facility, existing patients that have yet to be placed, or existing patients that have already been placed.

If there are notifications for new patients in step 508, then the user selects a link and is redirected in step 510 to a page that allows the user to set up a page for the patient, prompts the user to initiate contact with the patient or the patient's representative, and allow the user to provide an assessment of the patient's needs. In step 512, the user is directed to a search page that allows the user to conduct a search for a facility that will meet the patient's needs. If suitable facilities are identified through the search in step 514, then in step 516, the user consults with the patient and/or relevant responsible parties to select a facility. In step 518, the patient is assigned to the selected facility, and the user follows up with the facility manager and updates the patient's home page before returning to the portal home page in step 506.

If suitable facilities are not identified in step 514, then the user is asked if they wish to continue by refining the search or starting a new search in step 520. If so, then the user is redirected to step 512 to search again. If not, then the patient is placed in the user's inbox in step 522 as an existing patient not yet assigned to placement.

If there are not any notifications for new patients in step 508, the user is directed to step 524. If there are notifications regarding an existing patient not yet assigned to a care facility in step 512, then the user is directed to the search page in step 512 and the process continues as described above. If there are not any notifications regarding an existing patient not yet assigned in step 512, then the user is redirected to step 526. If there are notifications in step 526 regarding an existing patient already assigned to a care facility, then in step 528, the user manages patient messages and notifications. After performing any management tasks in step 528, the user is returned to the portal home page in step 506.

When all tasks of the user are complete, the user may log out of the portal in step 530, which causes them to exit the portal and return to the service home page in step 599.

### 5. Third Party Registration and Access

Referring to FIG. 6, a process 600 is illustrated for registering and/or providing access to the placement service by third parties, such as family of the patient, suppliers of medical equipment and supplies, etc. The third party registration process 600 is implemented by routine 113 of web application 110, which provides suitable instructions to render and process a series of graphical user interfaces to a user seeking to register or obtain access as a third party. From the home page of the placement service, the user is asked if they have an account with the service in step 602. If so, then the user is directed to a sign on routine in step 604. If authenticated in step 606, the user is redirected to a new page in step 608 to check the news feed(s) for any patients to which they are connected, or to read and/or send messages to connections, or to post and/or share pictures. If not authenticated in step 606, the user is returned to the sign on screen in step 604. The user can also search for other patients to connect to, as well as send connection requests, in step 610. When done, the user logs out of the portal in step 612, and is returned to the placement service home page in step 699.

If the user does not have an account with the placement service in step 602, then the user is redirected to step 620, where they are presented with a web page for requesting access. At this page, the user provides their real name and contact information, and selects a username. Further, the user provides the name of the patient that the user seeks to connect with, and their relationship to the patient. In step 622, the system searches for the patient. If the patient name is found in the database in step 624, then the user's request is redirected to the inbox of the care professional in step 626. If the patient name is not found in the database in step 624, then the placement service administrator is sent a notification in step 628. The admin may then contact the requestor and/or take other steps to verify the identity of the requestor and his relationship to the patient. Once the new third party user is authenticated, this branch redirects the user to step 626, where all requests end up in the inbox of the admin.

In step 628, the placement service admin verifies the identity and relationship of the third party and seeks consent from the patient for access by this person. In step 630, the placement service admin creates an account for the third party user and assigns a temporary password, then sends an electronic invitation, e.g., by email, to the third party, including a link that the third party must follow to complete registration.

### 6. Patient Submission

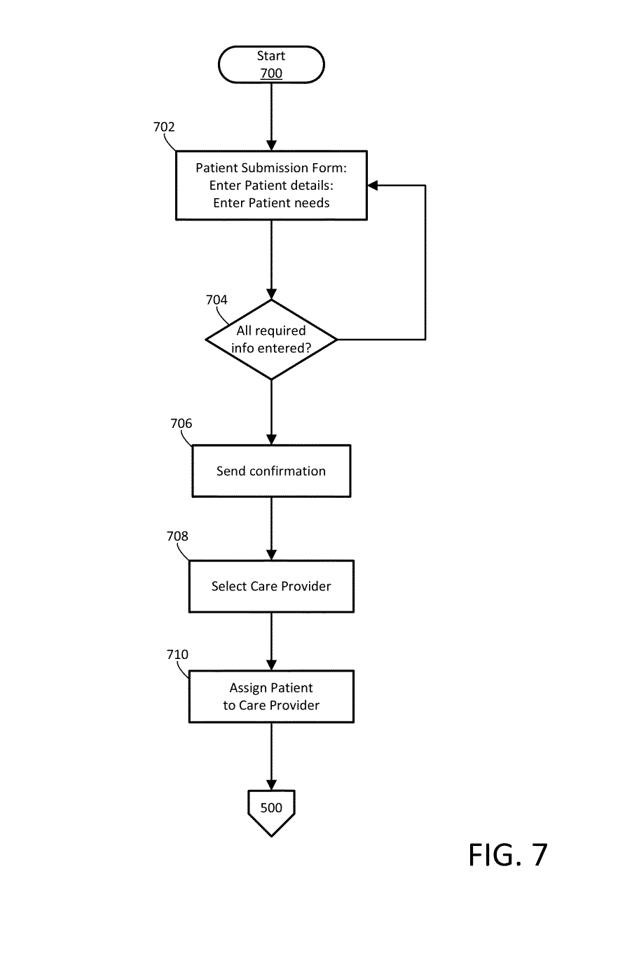

Referring to FIG. 7, a process 700 is illustrated for submitting a patient to the placement service. Any user can navigate to the placement service home page, and in step 702, the user can select and complete a patient submission form. Details about the patient and the submitter (if not the same) are entered in the patient submission form, as well as the patient's needs for a care facility. In step 704, if all required information has been entered into the form, then the user (patient or patient representative) is redirected to step 706. If all required information has not been entered in step 704, then the user is redirected back to step 702 to revise and resubmit the information.

In step 706, the system sends a confirmation email to the user as well as redirecting the user to a confirmation web page. In step 708, the system selects a care professional for the patient. This may be accomplished manually by a placement service admin, or preferably, automatically by the system in accord with programmed instructions. Automatic selection can be implemented using a programmed algorithm that takes into account various factors like patient location, patient needs, expertise of the care professional, etc. Finally, the patient will be managed by the care professional as set forth in process 500 shown in FIG. 5.

### 7. Factors for Patient Needs and Facility Features

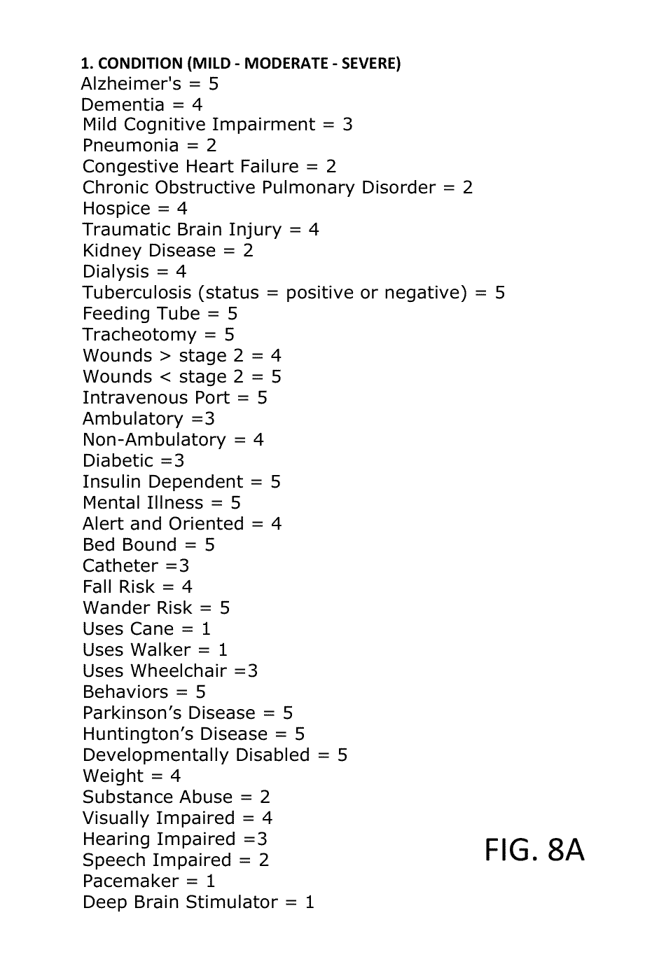

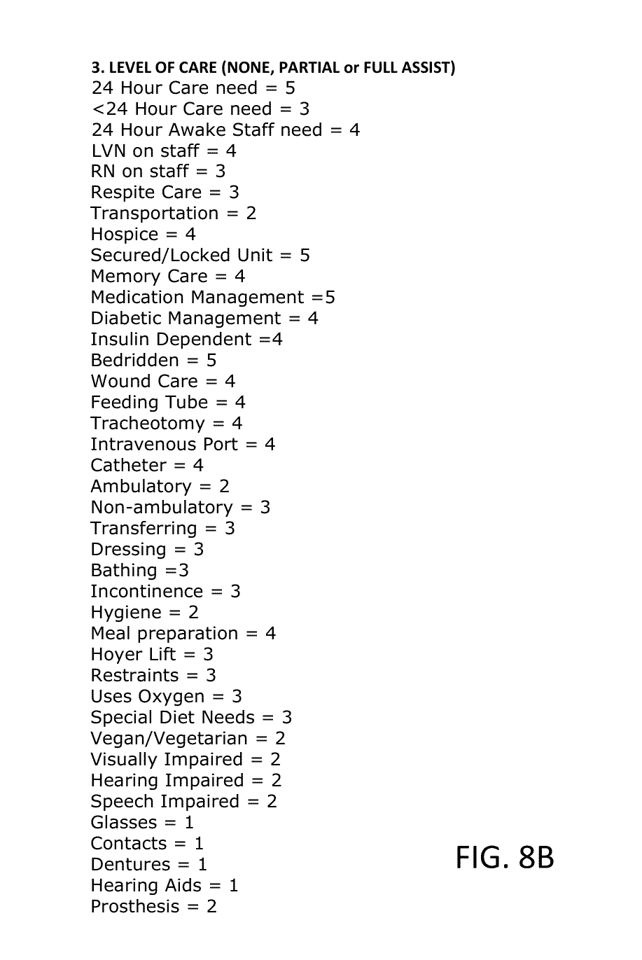

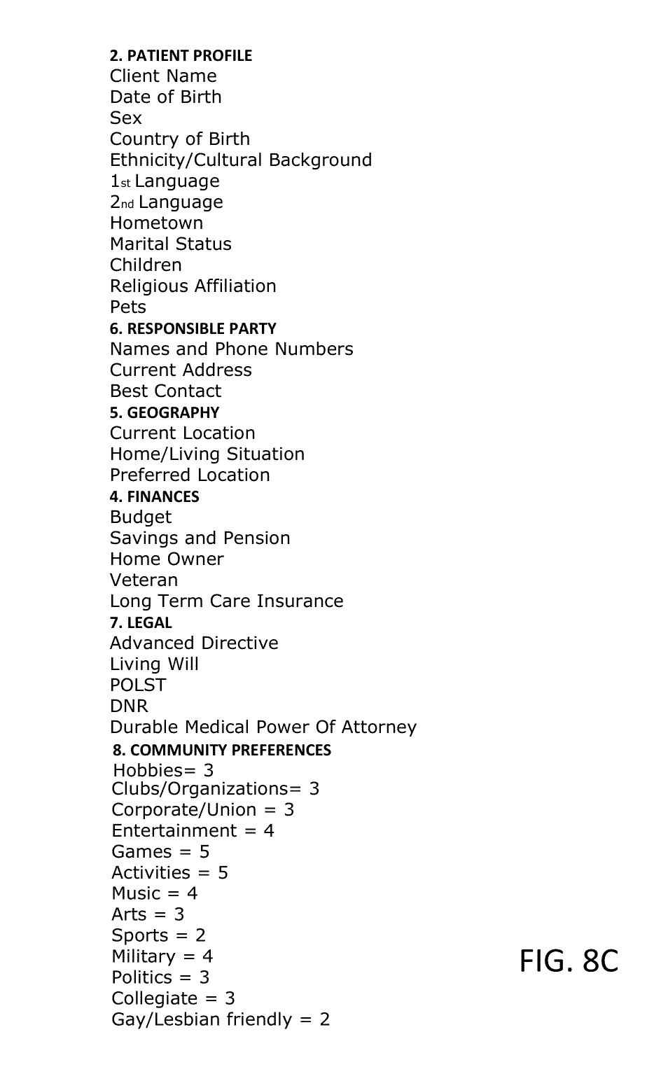

As noted above, a best fit match between the needs of the patient and the features of the facilities can be determined by evaluating individual factors that define the patient needs and/or the facility features, for example, by assigning weights to the factors and performing a mathematical and/or statistical analysis that considers all relevant factors. Performing an assessment of the patient's need can be form-driven by the web application in order to obtain a comprehensive list of common factors to consider. FIG. 8A shows a list of individual factors related to the patient's health, and a weight from 1 (mild) to 5 (severe) may be assigned to each factor as shown. FIG. 8B shows a list of individual factors related to the level of care required by the patient, and a weight from 1 (no care required) to 5 (full assistance required) may be assigned to each factor. FIG. 8C shows a number of lists of additional individual factors related to, for example, the patient profile; the responsible party; geography; patient finances; legal issues; and community preferences. Weights may also be assigned to each of the factors shown in FIG. 8C. A similar assessment can be made and form-driven for the factors related to features of the facilities, such as number of beds, number of staff, availability of in-house physical therapy, etc., and each of the factors can be assigned a weight.

### 8. Conclusion

While various implementations have been described herein, it should be understood that they have been presented by way of example only, and not limitation. Thus, the breadth and scope of the present application should not be limited by any of the implementations described herein, but should be defined only in accordance with the following and later-submitted claims and their equivalents.

1. A method for placing a patient in a patient care facility, comprising:
storing, in a database, facility data for a plurality of patient care facilities in terms of a plurality of patient care features;
receiving, at a server, an assessment of patient needs related to the patient care features for a patient; and
selecting, by the server, at least one of the patient care facilities on the basis of a match between patient needs and the patient care features of at least one of the facilities.

2. The method of claim 1, further comprising:
generating, by the server, a user interface configured to display appropriate content related to the patient to various authorized users of a patient placement system, the content including the selected patient care facility.

3. The method of claim 1, the selection step further comprising:
generating a list of a plurality of the patient care facilities that are a best match between patient needs and the patient care features.

4. The method of claim 1, further comprising:
receiving facility data from a plurality of facility operators.

5. The method of claim 4, further comprising:
verifying the facility data received from the plurality of facility operators.

6. The method of claim 1, further comprising:
granting access to a case manager; and
receiving the assessment of patient needs from the case manager;

7. The method of claim 2, further comprising:
granting access to the content to a plurality of individuals for the benefit of the patient, each different class of the individuals being granted access that is limited in scope by their relationship to the patient.

8. The method of claim 1, further comprising:
receiving as part of the assessment a plurality of patient factors that define patient needs;
assigning a weight to each patient factor; and
selecting the match between patient needs and the patient care features by evaluating the weights assigned to each patient factor.

9. The method of claim 8, further comprising:
assigning a weight to each patient care feature; and
selecting the match between patient needs and the patient care features by evaluating the weights assigned to each patient factor and each patient care feature.

10. The method of claim 1, further comprising:
generating a web page for the patient to display information related to placement of the patient in a patient care facility; and
granting access to the web page to a plurality of individuals for the benefit of the patient, each different class of the individuals being granted access at a level based on their relationship to the patient.

11. A non-transitory computer-readable storage medium encoded with executable instructions for selecting placement for a patient in a patient care facility, which, when executed by a processor cause the process or carry out the steps of:
storing, in a database, facility data for a plurality of patient care facilities in terms of a plurality of patient care features;
receiving, at a server, an assessment of patient needs related to the patient care features for a patient; and
selecting, by the server, at least one of the patient care facilities on the basis of a match between patient needs and the patient care features of at least one of the facilities.

12. The computer-readable medium of claim 11, the instructions further comprising:
generating, by the server, a user interface configured to display appropriate content related to the patient to various authorized users of a patient placement system, the content including the selected patient care facility.

13. The computer-readable medium of claim 11, the instructions further comprising:
generating a list of a plurality of the patient care facilities that are a best match between patient needs and the patient care features.

14. The computer-readable medium of claim 11, the instructions further comprising:
receiving facility data from a plurality of facility operators.

15. The computer-readable medium of claim 14, the instructions further comprising:
verifying the facility data received from the plurality of facility operators.

16. The computer-readable medium of claim 11, the instructions further comprising:
granting access to a case manager; and
receiving the assessment of patient needs from the case manager;

17. The computer-readable medium of claim 12, the instructions further comprising:
granting access to the content to a plurality of individuals for the benefit of the patient, each different class of the individuals being granted access at a level that is based on their relationship to the patient.

18. A system for selecting placement for a patient in a patient care facility, comprising:
a processor; and
one or more stored sequences of instructions which, when executed by the processor, cause the processor to carry out the steps of:
storing, in a database, facility data for a plurality of patient care facilities in terms of a plurality of patient care features;
receiving, at the processor, an assessment of patient needs related to the patient care features for a patient; and
selecting, by the processor, at least one of the patient care facilities on the basis of a match between patient needs and the patient care features of at least one of the facilities.

19. The system of claim 18, wherein the steps executed by the processor further comprise:
generating, by the server, a user interface configured to display appropriate content related to the patient to various authorized users of a patient placement system, the content including the selected patient care facility.

20. The system of claim 18, wherein the steps executed by the processor further comprise:
generating a list of a plurality of the patient care facilities that are a best match between patient needs and the patient care features.
